(19) United States
(12) Patent Application Publication
(10) Pub. No.: US 2025/0374163 A1
(43) Pub. Date: Dec. 4, 2025

(54) MANAGEMENT METHOD, MANAGEMENT APPARATUS FOR MANAGING MOBILE STATIONS

(71) Applicant: JVCKENWOOD Corporation, Yokohama-shi (JP)

(72) Inventor: Tomonori NAGAHAMA, Yokohama-shi (JP)

(21) Appl. No.: 19/298,648

(22) Filed: Aug. 13, 2025

Related U.S. Application Data
(63) Continuation of application No. PCT/JP2024/003238, filed on Feb. 1, 2024.

(30) Foreign Application Priority Data
Feb. 15, 2023 (JP) 2023-021521

(51) Int. Cl. H04W 40/22; H04W 4/02; H04W 4/029

(52) U.S. Cl. CPC H04W 40/22; H04W 4/027; H04W 4/029

(57) ABSTRACT

A derivation unit derives a first inter-mobile-station distance, derives a first relative velocity vector, derives a second inter-mobile-station distance, and derives a second relative velocity vector. A determination unit determines whether to maintain a relay between the base station and the forwarded mobile station by the first forwarding mobile station or to switch the relay to the second forwarding mobile station, based on the first inter-mobile-station distance, the first relative velocity vector, the second inter-mobile-station distance, and the second relative velocity vector.

### CROSS-REFERENCE TO RELATED APPLICATION

This application is based upon and claims the benefit of priority from the prior Japanese Patent Application No. 2023-021521, filed on Feb. 15, 2023, the entire contents of which is incorporated herein by reference.

### BACKGROUND

### 1. Technical Field

The present disclosure relates to a management technology and, in particular, to a management method and a management apparatus for managing mobile stations.

### 2. Description of the Related Art

A mobile station located outside a communication-enabled area of a base station cannot communicate with the base station. To enable communication between such a mobile station and the base station, a further mobile station located within the communication-enabled area relays communication between the mobile station and the base station (e.g., Patent Literature 1).
[Patent Literature 1] JP2001-285936

When the mobile station moves, the combination of a mobile station that should relay communication within the communication-enabled area (hereinafter referred to as “forwarding mobile station”) and a mobile station for which the forwarding mobile station relays communication outside the communication-enabled area (hereinafter referred to as “forwarded mobile station”) may have to be changed to maintain the communication quality (signal quality) depending on the arrangement of the mobile stations. In the case that at least one of the forwarding mobile station or the forwarded mobile station moves, therefore, a means for changing the combination of the forwarding mobile station and the forwarded mobile station is called for.

### SUMMARY

A management method according to an embodiment is a management method for a communication system including a base station that forms a communication service area in which communication is enabled, a forwarded mobile station located outside the communication service area, a first forwarding mobile station located within the communication service area and relaying communication between the base station and the forwarded mobile communication, and a second forwarding mobile station located within the communication service area and not relaying communication between the base station and the forwarded mobile station, the management method including: acquiring position information on and a velocity vector of the forwarded mobile station, position information on and a velocity vector of the first forwarding mobile station, and position information on and a velocity vector of the second forwarding mobile station; deriving a first inter-mobile-station distance based on the position information on the forwarded mobile station and the position information on the first forwarding mobile station, deriving a first relative velocity vector based on the velocity vector of the forwarded mobile station and the velocity vector of the first forwarding mobile station, deriving a second inter-mobile-station distance based on the position information on the forwarded mobile station and the position information on the second forwarding mobile station, and deriving a second relative velocity vector based on the velocity vector of the forwarded mobile station and the velocity vector of the second forwarding mobile station; and determining whether to maintain a relay between the base station and the forwarded mobile station by the first forwarding mobile station or to switch the relay to the second forwarding mobile station, based on the first inter-mobile-station distance, the first relative velocity vector, the second inter-mobile-station distance, and the second relative velocity vector.

Another embodiment relates to a management apparatus. The apparatus is a management apparatus adapted to manage a communication system including a base station that forms a communication service area in which communication is enabled, a forwarded mobile station located outside the communication service area, a first forwarding mobile station located within the communication service area and relaying communication between the base station and the forwarded mobile communication, and a second forwarding mobile station located within the communication service area and not relaying communication between the base station and the forwarded mobile station, the management apparatus including: an acquisition unit that acquires position information on and a velocity vector of the forwarded mobile station, position information on and a velocity vector of the first forwarding mobile station, and position information on and a velocity vector of the second forwarding mobile station; a derivation unit that derives a first inter-mobile-station distance based on the position information on the forwarded mobile station and the position information on the first forwarding mobile station, derives a first relative velocity vector based on the velocity vector of the forwarded mobile station and the velocity vector of the first forwarding mobile station, derives a second inter-mobile-station distance based on the position information on the forwarded mobile station and the position information on the second forwarding mobile station, and derives a second relative velocity vector based on the velocity vector of the forwarded mobile station and the velocity vector of the second forwarding mobile station; and a determination unit that determines whether to maintain a relay between the base station and the forwarded mobile station by the first forwarding mobile station or to switch the relay to the second forwarding mobile station, based on the first inter-mobile-station distance, the first relative velocity vector, the second inter-mobile-station distance, and the second relative velocity vector.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of a communication system according to the exemplary embodiment;

FIG. 2 shows a configuration of the management apparatus of FIG. 1;

FIG. 3 is a flowchart showing steps performed by the management apparatus of FIG. 2 to determine a role and a group;

FIG. 4 shows a data structure of a status table stored in the storage unit of FIG. 2;

FIG. 5 shows another data structure of the status table stored in the storage unit of FIG. 2;

FIG. 6 is a flowchart showing steps performed by the management apparatus of FIG. 2 to determine a role;

FIG. 7 shows yet another data structure of the status table stored in the storage unit of FIG. 2;

FIG. 8 is a flowchart showing forwarding assignment steps performed by the management apparatus of FIG. 2;

FIG. 9 is a flowchart showing steps performed by the management apparatus of FIG. 2 to calculate an amount of change;

FIG. 10 shows yet another data structure of the status table stored in the storage unit of FIG. 2; and

FIG. 11 is a flowchart showing steps performed by the management apparatus of FIG. 2 for a timeout.

### DETAILED DESCRIPTION

The invention will now be described by reference to the preferred embodiments. This does not intend to limit the scope of the present invention, but to exemplify the invention.

A summary will be given before describing the exemplary embodiment in specific details. The exemplary embodiment relates to a communication system including a base station and a mobile station. The base station forms a communication service area having a certain range, can communicate with mobile stations within the communication service area, and cannot communicate with mobile stations outside the communication service area. To allow a mobile station located outside the communication service area to communicate with the base station, the communication system according to the exemplary embodiment is configured such that communication between a mobile station outside the service area (hereinafter referred to as a “forwarded mobile station”) and the base station is relayed by a mobile station within the service area (hereinafter referred to as a “forwarding mobile station”).

In the case that the forwarding mobile station is mounted on a vehicle and the forwarded mobile station is carried by a user, the forwarding mobile station and the forwarded mobile station can move, and their relative positions vary. Even if the forwarding mobile station is located at a position where communication between the forwarded mobile station and the base station can be relayed, therefore, the forwarding mobile station may no longer be positioned to relay communication between the forwarded mobile station and the base station as a result of the movement of at least one of the forwarded mobile station or the forwarding mobile station. In the case that at least one of the forwarding mobile station or the forwarded mobile station moves, it is required to change the combination of the forwarding mobile station and the forwarded mobile station appropriately.

The communication system according to the exemplary embodiment changes the combination of the forwarding mobile station and the forwarded mobile station based on the position and the relatively determined velocity vector (hereinafter referred to as “relative velocity vector”) of the forwarding mobile station and the forwarded mobile station.

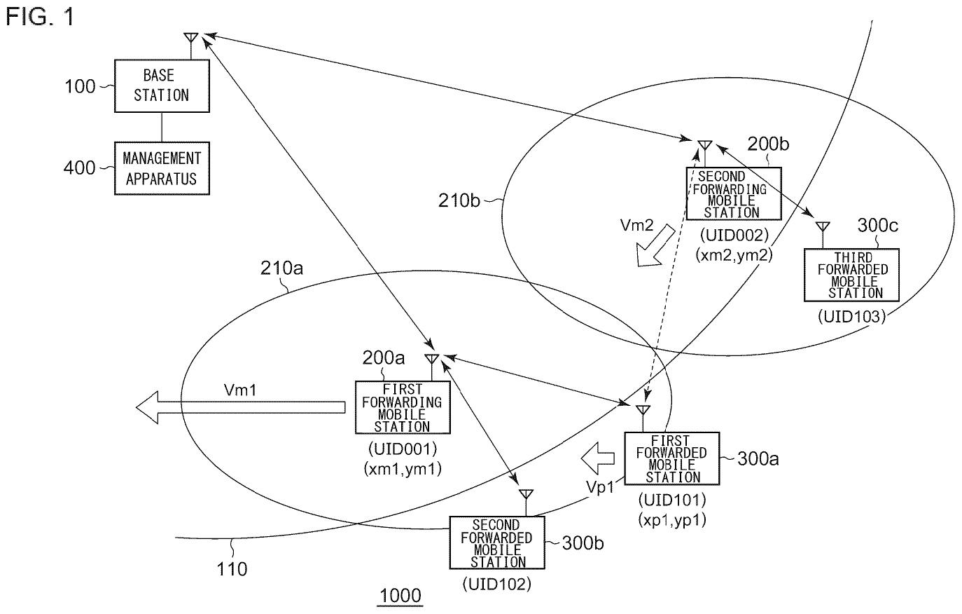

FIG. 1 shows a configuration of a communication system 1000. The communication system 1000 includes a base station 100, a first forwarding mobile station 200a, a second forwarding mobile station 200b, which are generically referred to as a forwarding mobile station 200, a first forwarded mobile station 300a, a second forwarded mobile station 300b, a third forwarded mobile station 300c, which are generically referred to as a forwarded mobile station 300, and a management apparatus 400. The number of base stations 100, the number of forwarding mobile stations 200, and the number of forwarded mobile stations 300 included in the communication system 1000 are not limited to “1”, “2”, “3”, respectively.

The base station 100 is a wireless apparatus capable of performing wireless communication. The base station 100 forms a communication service area 110 in which wireless communication is enabled and communicates with a mobile station located within the communication service area 110. The forwarding mobile station 200 is a mobile station located within the communication service area 110 and capable of communicating with the base station 100. Further, the forwarding mobile station 200 is, for example, mounted on a vehicle and can move. The forwarded mobile station 300 is a mobile station located outside the communication service area 110 and is not capable of communicating with the base station 100. Further, the forwarded mobile station 300 is, for example, carried by the user and can move.

To enable communication between the base station 100 and the forwarded mobile station 300 in such a situation, the forwarding mobile station 200 relays communication between the base station 100 and the forwarded mobile station 300. The range in which the first forwarding mobile station 200a can communicate with the forwarded mobile station 300 is indicated as a first forwarding-enabled range 210a, and the range in which the second forwarding mobile station 200b can communicate with the forwarded mobile station 300 is indicated as a second forwarding-enabled range 210b. The first forwarded mobile station 300a and the second forwarded mobile station 300b located within the first forwarding-enabled range 210a can communicate with the first forwarding mobile station 200a, and the third forwarded mobile station 300c located within the second forwarding-enabled range 210b can communicate with the second forwarding mobile station 200b.

The first forwarding mobile station 200a, the first forwarded mobile station 300a, and the second forwarded mobile station 300b form one group, and the first forwarding mobile station 200a relays communication between the base station 100 and the first forwarded mobile station 300a and relays communication between the base station 100 and the second forwarded mobile station 300b. Further, the second forwarding mobile station 200b and the third forwarded mobile station 300c form one group, and the second forwarding mobile station 200b relays communication between the base station 100 and the third forwarded mobile station 300c. Since the second forwarding mobile station 200b and the first forwarded mobile station 300a are not in the same group, the second forwarding mobile station 200b does not relay communication between the base station 100 and the first forwarded mobile station 300a.

These groups comprised of the forwarding mobile stations 200 and the forwarded mobile stations 300 are generated in the management apparatus 400 connected to the base station 100. To generate a group in the management apparatus 400 or to change a group in the management apparatus 400, the following process is performed in the communication system 1000.

Each forwarding mobile station 200 and each forwarded mobile station 300 are provided with a positioning function according to GNSS (Global Navigation Satellite System) and periodically measure their positions. The forwarding mobile station 200 periodically transmits the measured position information to the base station 100, and the forwarded mobile station 300 periodically transmits the measured position information to the base station 100 via the forwarding mobile station 200. The forwarded mobile station 300 that is not included in any group broadcasts the position information, and the forwarding mobile station 200 that receives the position information transmits the position information to the base station 100.

The management apparatus 400 acquires the position information on each forwarding mobile station 200 and the position information on each forwarded mobile station 300 via the base station 100. As a result, the management apparatus 400 or the base station 100 recognizes each forwarding mobile station 200 and each forwarded mobile station 300. The management apparatus 400 categorizes mobile stations located within the forwarding-enabled range 210 based on the position information into the forwarding mobile station 200 and the mobile station that does not relay communication (hereinafter referred to as “normal mobile station”). The normal mobile station only communicates with the base station 100. The classification into the forwarding mobile station 200 and the normal mobile station is made based on, for example, transmission power (also referred to as aerial power or transmission output) and movement speed.

The management apparatus 400 calculates the velocity vector of each forwarding mobile station 200 based on the position information on each forwarding mobile station 200 and calculates the velocity vector of each forwarded mobile station 300 based on the position information on each forwarded mobile station 300. The management apparatus 400 also calculates the distance between the forwarding mobile station 200 and the forwarded mobile station 300. Based on the velocity vector and the distance, the management apparatus 400 generates a group that includes the forwarding mobile station 200 and the forwarded mobile station 300. This process enables changing the group in the event that at least one of the forwarding mobile station 200 or the forwarded mobile station 300 moves. The management apparatus 400 transmits information on the group to each forwarding mobile station 200.

Hereinafter, it is given that the identifier (UID) of the first forwarding mobile station 200a is “001”, the UID of the second forwarding mobile station 200b is “002”, the UID of the first forwarded mobile station 300a is “101”, the UID of the second forwarded mobile station 300b is “102”, and the UID of the third forwarded mobile station 300c is “103”. Further, the position information on the first forwarding mobile station 200a is represented as (xm1, ym1), the position information on the second forwarding mobile station 200b is represented as (xm2, ym2), and the position information on the first forwarded mobile station 300a is represented as (xp1, yp1).

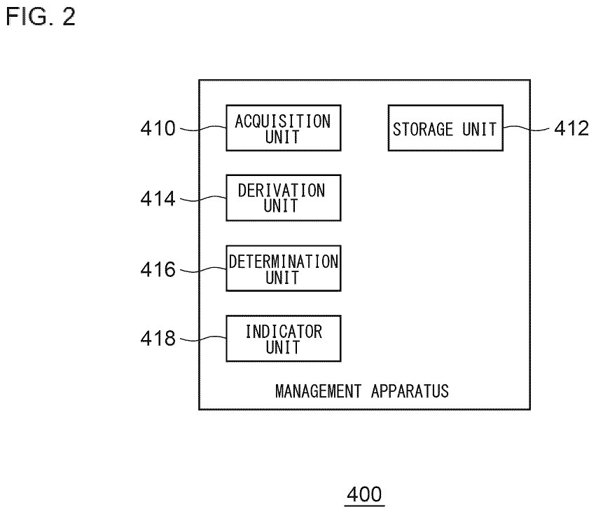

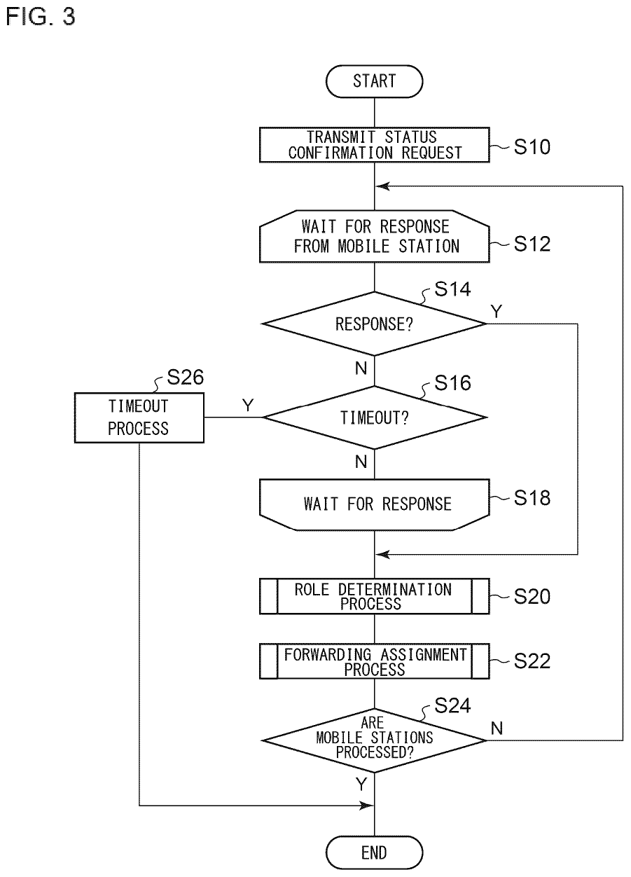

FIG. 2 shows a configuration of the management apparatus 400. The management apparatus 400 includes an acquisition unit 410, a storage unit 412, a derivation unit 414, a determination unit 416, and an indicator unit 418. Hereinafter, the process in the management apparatus 400 will be described with reference also to FIGS. 3 to 11.

FIG. 3 is a flowchart showing steps performed by the management apparatus 400 to determine a role and a group. The acquisition unit 410 of the management apparatus 400 transmits a status confirmation request for the status of each forwarding mobile station 200 and each forwarded mobile station 300 to the base station 100 (S10). The base station 100 transmits the status confirmation request to the forwarding mobile station 200, and the forwarding mobile station 200 transmits the status confirmation request to the forwarded mobile station 300. The forwarding mobile station 200 that receives the status confirmation request transmits a response to the base station 100, the response including the status of the forwarding mobile station 200 (e.g., the position information on and information on the transmission output of the forwarding mobile station 200). Further, the forwarded mobile station 300 that receives the status confirmation request transmits a response to the forwarding mobile station 200, the response including information on the status of the forwarded mobile station 300 (e.g., the position information on and information on the transmission output of the forwarded mobile station 300). The forwarding mobile station 200 forwards the response from the forwarded mobile station 300 to the base station 100. The forwarding mobile station 200 and the forwarded mobile station 300 may periodically transmit the position information regardless of the status confirmation request.

The acquisition unit 410 waits for the response from the forwarding mobile station 200 or the forwarded mobile station 300 (S12). If there is no response (N in S14) and a timeout has not occurred (N in S16), the acquisition unit 410 continues to wait for a response (S18). If there is a response (Y in S14), step 16, step 18 are skipped. This allows the acquisition unit 410 to acquire information on the status of the forwarding mobile station 200 or the forwarded mobile station 300. As a result, the acquisition unit 410 acquires the position information on the forwarding mobile station 200 or the forwarded mobile station 300. The acquisition unit 410 stores the acquired status information in the storage unit 412.

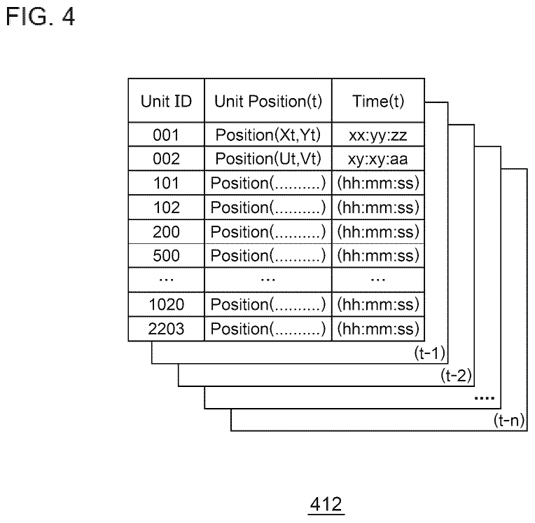

FIG. 4 shows a data structure of a status table stored in the storage unit 412. “Unit ID” denotes the UID for each forwarding mobile station 200 or each forwarded mobile station 300, “Unit Position” denotes the position information on each forwarding mobile station 200 or each forwarded mobile station 300, and “Time” denotes the time when the position information is acquired in the forwarding mobile station 200 or the forwarded mobile station 300 or the management apparatus 400. The status table like this is generated at time t, t-1, t-2, . . . , t-n.

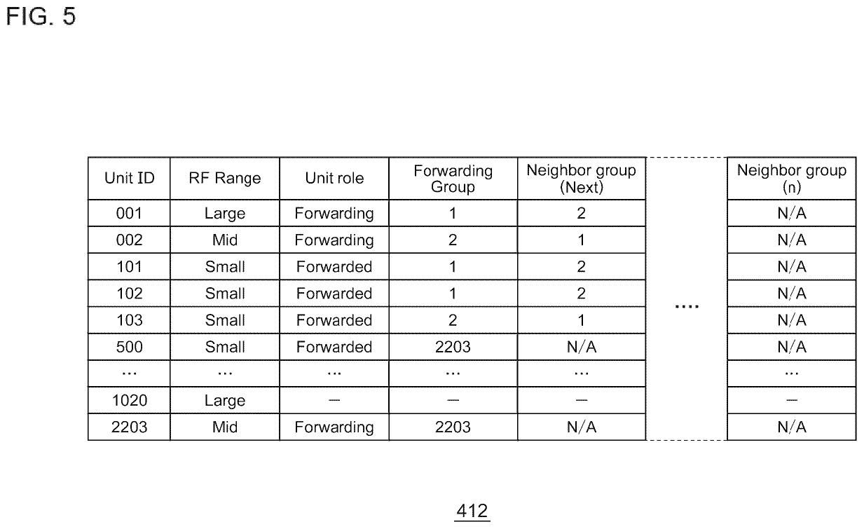

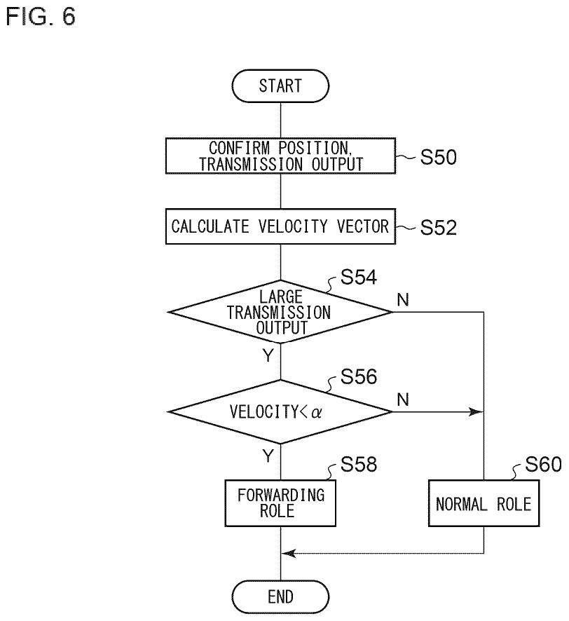

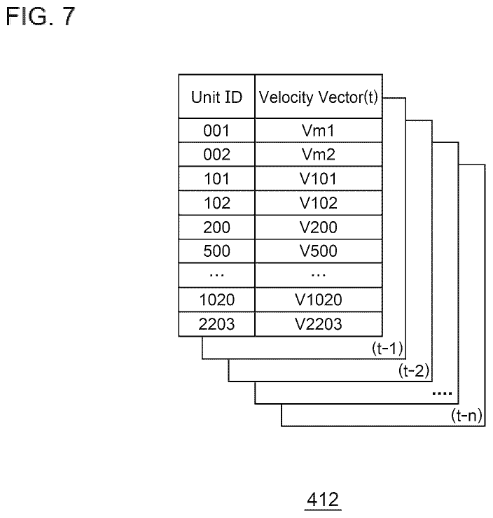

FIG. 5 shows another data structure of the status table stored in the storage unit 412. “RF Range” denotes the transmission power. “Large” corresponds to the transmission output: large, “Mid” corresponds to the transmission output: medium, and “Small” corresponds to the transmission output: small. “Unit role” denotes the role of the mobile station. “Forwarding” corresponds to the forwarding mobile station 200, and “Forwarded” corresponds to the forwarded mobile station 300. “Forwarding Group” indicates the aforementioned group, and “Neighbor group” indicates the surrounding group. Reference is made back to FIG. 3. The determination unit 416 executes a role determination process (S20). To show the role determination process, FIGS. 6 and 7 will also be used.

FIG. 6 is a flowchart showing steps performed by the management apparatus 400 to determine a role. The determination unit 416 refers to the status table stored in the storage unit 412 and checks the position information on and the transmission output of each forwarding mobile station 200 or each forwarded mobile station 300 (S50). The acquisition unit 410 calculates the velocity vector of each forwarding mobile station 200 or each forwarded mobile station 300 based on the position information in the status table stored in the storage unit 412 (S52). For example, the velocity vector of the first forwarding mobile station 200a is calculated by dividing the difference between the position information on the first forwarding mobile station 200a at time t and the position information at time t-1 by the time difference between time t and time t-1. The same applies to other forwarding mobile stations 200 and forwarded mobile station 300. The acquisition unit 410 stores the calculated velocity vector in the storage unit 412. FIG. 7 shows yet another data structure of the status table stored in the storage unit 412. A velocity vector is stored for each UID. The status table like this is generated at time t, t-1, t-2, . . . , t-n. Reference is made back to FIG. 6.

The determination unit 416 determines that the mobile station, among the mobile stations with the position information included in the communication service area 110, for which the transmission output is large (Y in S54) and the absolute value of the velocity vector, i.e., the speed, is smaller than a constant value a (Y in S56) has forwarding role, i.e., is the forwarding mobile station 200 (S58). Meanwhile, the determination unit 416 determines that the mobile station, among the mobile stations with the position information included in the communication service area 110, for which the transmission output is not large (N in S54) or the speed is not smaller than the constant value α (N in S56) has the normal role (S60).

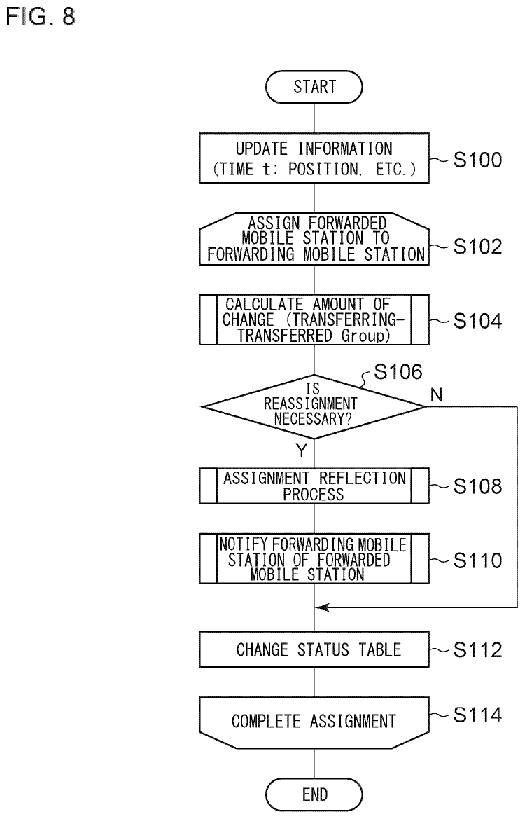

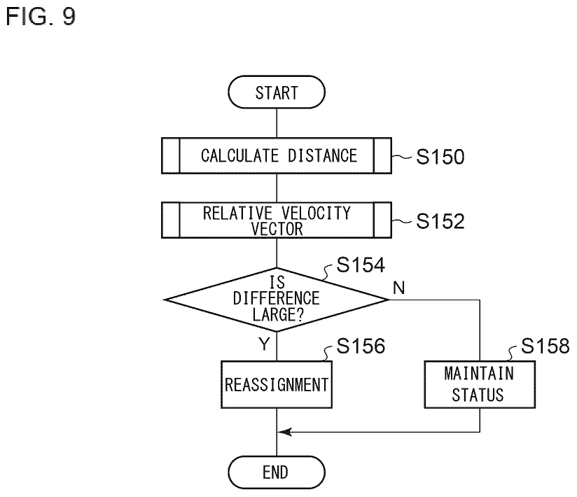

Reference is made back to FIG. 3. The derivation unit 414 and the determination unit 416 execute a forwarding assignment process (S22). FIG. 8 will also be used to describe the forwarding assignment process. FIG. 8 is a flowchart showing forwarding assignment steps performed by the management apparatus 400. The acquisition unit 410 updates the information in the status table stored in the storage unit 412 (S100). The determination unit 416 executes the reassignment of the forwarded mobile station 300 to the forwarding mobile station 200 (S102). The derivation unit 414 calculates the amount of change (104). FIG. 9 is also used to describe the process of calculating the amount of change.

FIG. 9 is a flowchart showing steps performed by the management apparatus 400 to calculate an amount of change. The derivation unit 414 calculates an inter-mobile-station distance Δd based on the position information on the forwarded mobile station 300 and the position information on the forwarding mobile station 200 (S150). For example, the derivation unit 414 derives a first inter-mobile-station distance Δd(p1, m1) based on the position information (xp1, yp1) on the first forwarded mobile station 300a and the position information (xm1, ym1) on the first forwarding mobile station 200a.

$$Δ d ( p 1 , m 1 ) ) = ( xm 1 , ym 1 ) - ( xp 1 , yp 1 )$$

Further, the derivation unit 414 derives a second inter-mobile-station distance Δd(p1, m2) based on the position information (xp1, yp1) on the first forwarded mobile station 300a and the position information (xm2, ym2) on the second forwarding mobile station 200b.

$$Δ d ( p 1 , m 2 ) = ( xm 2 , ym 2 ) - ( xp 1 , yp 1 )$$

The derivation unit 414 calculates a relative velocity vector based on the velocity vector of the forwarded mobile station 300 and the velocity vector of the forwarding mobile station 200 (S152). For example, the derivation unit 414 derives a first relative velocity vector Δv(p1, m1) based on the velocity vector Vp1 of the first forwarded mobile station 300a and the velocity vector Vm1 of the first forwarding mobile station 200a.

$$Δ v ( p 1 , m 1 ) = Vm 1 - Vp 1$$

Further, the derivation unit 414 derives a second relative velocity vector Δv(p1, m2) based on the velocity vector Vp1 of the first forwarded mobile station 300a and the velocity vector Vm2 of the second forwarding mobile station 200b.

$$Δ v ( p 1 , m 2 ) = Vm 2 - Vp 1$$

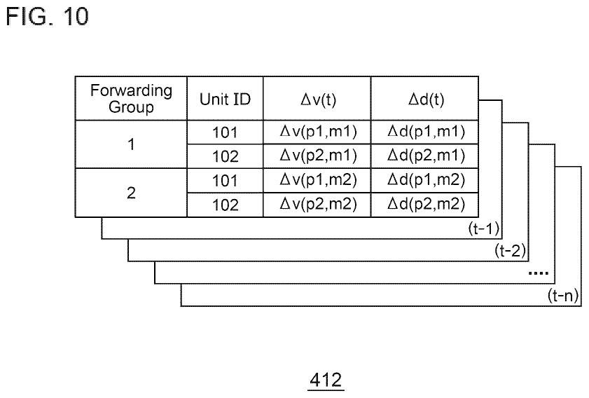

The derivation unit 414 stores the inter-mobile-station distance and the relative velocity vector in the storage unit 412. FIG. 10 shows yet another data structure of the status table stored in the storage unit 412. As shown, the inter-mobile-station distance and the relative velocity vector for various combinations of the forwarding mobile station 200 and the forwarded mobile station 300 are stored.

The determination unit 416 determines whether the difference is large based on the inter-mobile-station distance and the relative velocity vector in the same group (S154). For example, the determination unit 416 determines whether the first inter-mobile-station distance Δd(p1, m1) is larger than a first threshold value and the first relative velocity vector Δv(p1, m1) is in the direction of increasing the first inter-mobile-station distance. The first threshold value is determined according to the transmission power of the first forwarding mobile station 200a. For example, the larger the transmission power of the first forwarding mobile station 200a, the larger the first threshold value. When this condition is met (Y in S154), the determination unit 416 determines to switch to a relay between the base station 100 and the first forwarded mobile station 300a by the second forwarding mobile station 200b (S156) provided that the second inter-mobile-station distance Δd(p1, m2) is equal to or smaller than a second threshold value and the second relative velocity vector Δv(p1, m2) is in the direction of not increasing the second inter-mobile-station distance Δd(p1, m2). The second threshold value is determined according to the transmission power of the second forwarding mobile station 200b. For example, the larger the transmission power of the second forwarding mobile station 200b, the larger the second threshold value.

When the second inter-mobile-station distance Δd(p1, m2) is larger than the second threshold value, or when the second relative velocity vector Δv(p1, m2) is in the direction of increasing the second inter-mobile-station distance Δd(p1, m2), switching is not performed. In this process, the forwarding mobile station 200 close to the forwarded mobile station 300 is selected. Also, the forwarding mobile station 200 having a small speed of moving away from the forwarded mobile station 300 is selected. Further, the forwarding mobile station 200 for which Av is oriented to approach the forwarded mobile station 300 is selected.

When the aforementioned condition is not met (N in S154) (e.g., when the first inter-mobile-station distance Δd(p1, m1) is equal to or smaller the first threshold value or the first relative velocity vector Δv(p1, m1) is in the direction of not increasing the first inter-mobile-station distance), on the other hand, the determination unit 416 determines to maintain a relay between the base station 100 and the first forwarded mobile station 300a by the first forwarding mobile station 200a (S158). Thus, the determination unit 416 determines whether to maintain a relay between the base station 100 and the first forwarded mobile station 300a by the first forwarding mobile station 200a or to switch to the relay between the base station 100 and the first forwarded mobile station 300a by the second forwarding mobile station 200b, based on the first inter-mobile-station distance Δd(p1, m1), the first relative velocity vector Δv(p1, m1), the second inter-mobile-station distance Δd(p1, m2), and the second relative velocity vector Δv(p1, m2). The same process is performed for other combinations of the forwarding mobile station 200 and the forwarded mobile station 300. Reference is made back to FIG. 8.

When reassignment is required (Y in S106), the determination unit 416 executes an assignment reflection process (S108). In the assignment reflection process (e.g., when it is determined to switch to a relay between the base station 100 and the first forwarded mobile station 300a by the second forwarding mobile station 200b), the process of excluding the first forwarded mobile station 300a from the group of the first forwarding mobile station 200a and adding the first forwarded mobile station 300a to the group of the second forwarding mobile station 200b is executed. The indicator unit 418 notifies the forwarding mobile station 200 of the assignment of the forwarded mobile station 300 (S110). For example, the indicator unit 418 notifies the first forwarding mobile station 200a of the exclusion of the first forwarded mobile station 300a and notifies the second forwarding mobile station 200b of the addition of the first forwarded mobile station 300a. Such a notification is made via the base station 100.

When giving a notification of a forwarding role, the base station 100 may manage a frequency set so as not to overlap with a surrounding group and may add information that allocates an optimal dedicated frequency to interact with the forwarded mobile station 300. Further, when giving a notification of a surrounding mobile station, the base station 100 may give a notification of information on the newly added forwarded mobile station 300 and on the forwarded mobile station 300 excluded from the forwarding (information on the next forwarding mobile station 200: UID, forwarding frequency information, etc.). When reassignment is not required (N in S106), on the other hand, step 108 and step 110 are skipped. The determination unit 416 changes the status table in the storage unit 412 (S112) according to the determined detail and completes the assignment (S114). Reference is made back to FIG. 3.

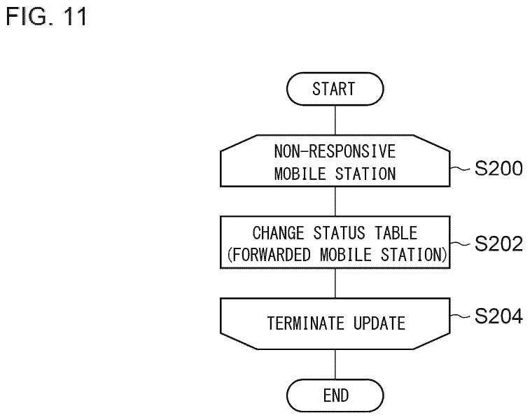

When the process for all mobile stations has not been completed (N in S24), the process is returned to step 12. When the process for all mobile stations is completed (Y in S24), the process is terminated. When a timeout occurs (Y in S16), on the other hand, the acquisition unit 410 executes a timeout process (S26). FIG. 11 is also used to describe the timeout process. FIG. 11 is a flowchart showing steps performed by the management apparatus 400 for a timeout. The acquisition unit 410 identifies the mobile station with no incoming calls (non-responding) (S200) and changes the status table stored in the storage unit 412 (S202). Specifically, the identified mobile station is determined to be the forwarded mobile station 300. After the status table is updated, the update is terminated (S204).

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

According to the exemplary embodiment, whether to maintain or change the current combination of the forwarding mobile station 200 and the forwarded mobile station 300 is determined based on the first inter-mobile-station distance, the first relative velocity vector, the second inter-mobile-station distance, and the second relative velocity vector. Therefore, the combination can be changed when at least one of the forwarding mobile station 200 or the forwarded mobile station 300 moves. Further, a determination is made to change the combination when the inter-mobile-station distance is larger than the first threshold value and the first relative velocity vector is in the direction of increasing the inter-mobile-station distance, provided that the second inter-mobile-station distance is equal to or smaller than the second threshold value and that the second relative velocity vector is in the direction of not increasing the second inter-mobile-station distance. Accordingly, switching of the relay can be executed smoothly. Further, the combination is maintained when the first inter-mobile-station distance is equal to or smaller than the first threshold value, or when the first relative velocity vector is in the direction of not increasing the first inter-mobile-station distance. Accordingly, the relay can be maintained. Further, since the first threshold value is determined according to the transmission power of the first forwarding mobile station, the first threshold value can be set appropriately. Further, since the second threshold value is determined according to the transmission power of the second forwarding mobile station, the second threshold value can be set appropriately.

The present disclosure has been described above based on an exemplary embodiment. In the exemplary embodiment, an audio signal has been described, but the exemplary embodiment is not limited thereto and is equally applicable to an information signal such as a data signal. The embodiment is intended to be illustrative only and it will be understood by those skilled in the art that various modifications to constituting elements and processes could be developed and that such modifications are also within the scope of the present disclosure.

What is claimed is:

1. A management method adapted to manage a communication system including a base station that forms a communication service area in which communication is enabled, a forwarded mobile station located outside the communication service area,
and a mobile station located within the communication service area, the management method comprising:
determining, based on a transmission power and a movement speed of the mobile station located within the communication service area, whether a role of the mobile station is a forwarding mobile station.

2. A management method for a communication system including a base station that forms a communication service area in which communication is enabled, a forwarded mobile station located outside the communication service area, a first forwarding mobile station located within the communication service area and relaying communication between the base station and the forwarded mobile communication, and a second forwarding mobile station located within the communication service area and not relaying communication between the base station and the forwarded mobile station, the management method comprising:
acquiring position information on and a velocity vector of the forwarded mobile station, position information on and a velocity vector of the first forwarding mobile station, and position information on and a velocity vector of the second forwarding mobile station;
deriving a first inter-mobile-station distance based on the position information on the forwarded mobile station and the position information on the first forwarding mobile station, deriving a first relative velocity vector based on the velocity vector of the forwarded mobile station and the velocity vector of the first forwarding mobile station, deriving a second inter-mobile-station distance based on the position information on the forwarded mobile station and the position information on the second forwarding mobile station, and deriving a second relative velocity vector based on the velocity vector of the forwarded mobile station and the velocity vector of the second forwarding mobile station; and
determining whether to maintain a relay between the base station and the forwarded mobile station by the first forwarding mobile station or to switch the relay to the second forwarding mobile station, based on the first inter-mobile-station distance, the first relative velocity vector, the second inter-mobile-station distance, and the second relative velocity vector.

3. The management method according to claim 2,
wherein the determining switches the relay between the base station and the forwarded mobile station to the second forwarding mobile station when the first inter-mobile-station distance is larger than a first threshold value and the first relative velocity vector is in a direction of increasing the first inter-mobile-station distance, provided that the second inter-mobile-station distance is equal to or smaller than a second threshold value and the second relative velocity vector is in a direction of not increasing the second inter-mobile-station distance.

4. The management method according to claim 2,
wherein the determining determines to maintain the relay between the base station and the forwarded mobile station by the first forwarding mobile station when the first inter-mobile-station is equal to or smaller than a first threshold value or the first relative velocity vector is in a direction of not increasing the first inter-mobile-station distance.

5. The management method according to claim 3,
wherein the first threshold value is determined according to a transmission power of the first forwarding mobile station, and
wherein the second threshold value is determined according to a transmission power of the second forwarding mobile station.

6. The management method according to claim 4,
wherein the first threshold value is determined according to a transmission power of the first forwarding mobile station.

7. A management apparatus adapted to manage a communication system including a base station that forms a communication service area in which communication is enabled, a forwarded mobile station located outside the communication service area, a first forwarding mobile station located within the communication service area and relaying communication between the base station and the forwarded mobile communication, and a second forwarding mobile station located within the communication service area and not relaying communication between the base station and the forwarded mobile station, the management apparatus comprising:
an acquisition unit that acquires position information on and a velocity vector of the forwarded mobile station, position information on and a velocity vector of the first forwarding mobile station, and position information on and a velocity vector of the second forwarding mobile station;
a derivation unit that derives a first inter-mobile-station distance based on the position information on the forwarded mobile station and the position information on the first forwarding mobile station, derives a first relative velocity vector based on the velocity vector of the forwarded mobile station and the velocity vector of the first forwarding mobile station, derives a second inter-mobile-station distance based on the position information on the forwarded mobile station and the position information on the second forwarding mobile station, and derives a second relative velocity vector based on the velocity vector of the forwarded mobile station and the velocity vector of the second forwarding mobile station; and
a determination unit that determines whether to maintain a relay between the base station and the forwarded mobile station by the first forwarding mobile station or to switch the relay to the second forwarding mobile station, based on the first inter-mobile-station distance, the first relative velocity vector, the second inter-mobile-station distance, and the second relative velocity vector.
